(19) United States
(12) Patent Application Publication
(10) Pub. No.: US 2025/0378391 A1
(43) Pub. Date: Dec. 11, 2025

(54) AGENT TRAINING METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Yu Shi, Beijing (CN); Le Zhang, Beijing (CN); Jingbo Zhou, Beijing (CN); Hui Xiong, Beijing (CN)

(73) Assignee: BEIJING BAIDU NETCOM SCIENCE TECHNOLOGY CO., LTD., Beijing (CN)

(21) Appl. No.: 19/310,720

(22) Filed: Aug. 26, 2025

(30) Foreign Application Priority Data
Jun. 19, 2025 (CN) 202510830751.4

(51) Int. Cl. G06N 20/00

(52) U.S. Cl. CPC G06N 20/00

(57) ABSTRACT

A method for training an agent includes: for each subtask of a sample task, determining action priorities for a plurality of first candidate actions in a plurality of sets of experience data corresponding to the subtask in an experience pool of the agent, wherein the action priorities represent values of the plurality of the first candidate actions; selecting target experience data corresponding to the subtask from the plurality of sets of experience data based on the action priorities; and training the agent based on the target experience data.

### CROSS-REFERENCE TO RELATED APPLICATIONS

The present application is based on and claims the priority of Chinese patent application No. 2025108307514 filed on Jun. 19, 2025, the entire contents of which are incorporated herein by reference.

### TECHNICAL FIELD

The disclosure relates to the field of computer technology, especially the field of artificial intelligence (AI) such as deep learning, large model, agent and the like, in particular to a method for training an agent, an electronic device and a storage medium.

### BACKGROUND

Agent is software, hardware or entity with autonomous capabilities and adaptability. Its goal is to recognize and simulate human intelligent behaviors. The agent can be regarded as a computing entity that can continuously and autonomously perform functions and interact with the environment. It has characteristics such as residency, reactivity, sociality and proactivity. The agent has a wide range of applications in the field of AI, such as in games and terminal applications (APPs), where they offer the dominances of high automation and high intelligence.

### SUMMARY

The disclosure provides a method for training an agent, an electronic device and a storage medium. The specific solution is provided below.

According to a first aspect of the disclosure, a method for training an agent is provided. The method includes:
for each subtask of a sample task, determining action priorities for a plurality of first candidate actions in a plurality of sets of experience data corresponding to the subtask in an experience pool of the agent, in which the action priorities represent values of the plurality of the first candidate actions;
selecting target experience data corresponding to the subtask from the plurality of sets of experience data based on the action priorities; and
training the agent based on the target experience data.

According to a second aspect of the disclosure, an electronic device is provided. The electronic device includes:
at least one processor; and
a memory communicatively connected to the at least one processor;
in which the memory stores instructions executable by the at least one processor, and
when the instructions are executed by the at least one processor, the at least one processor is caused to implement the method described in the above embodiments.

According to a third aspect of the disclosure, a non-transitory computer-readable storage medium having computer instructions stored thereon is provided. The computer instructions are used to cause a computer to implement the method described in the above embodiments.

According to a fourth aspect of the disclosure, a computer program product is provided. The computer program product includes a computer program, and when the computer program is executed by a processor, the steps of the method described in the above embodiments are implemented.

It should be understood that the content described in this section is not intended to identify key or important features of the embodiments of the disclosure, nor is it intended to limit the scope of the disclosure. Additional features of the disclosure will be easily understood from the following description.

### BRIEF DESCRIPTION OF THE DRAWINGS

The accompanying drawings are used to better understand the solution and do not constitute a limitation to the disclosure, in which:

FIG. 1 is a flowchart of a method for training an agent provided by an embodiment of the disclosure.

FIG. 2 is a flowchart of a method for training an agent provided by another embodiment of the disclosure.

FIG. 3 is a flowchart of a method for training an agent provided by yet another embodiment of the disclosure.

FIG. 4 is a schematic structural diagram of an apparatus for training an agent provided by an embodiment of the disclosure.

FIG. 5 is a block diagram of an electronic device that is used for implementing the method for training the agent of the embodiments of the disclosure.

### DETAILED DESCRIPTION

The following description of example embodiments of the disclosure is provided in combination with the accompanying drawings, which includes various details of the embodiments of the disclosure to aid in understanding, and should be considered merely exemplary. Those skilled in the art understood that various changes and modifications can be made to the embodiments described herein without departing from the scope and spirit of the disclosure. For the sake of clarity and brevity, descriptions of well-known functions and structures are omitted from the following description.

It should be noted that data acquisition, storage, usage and processing in the technical solution of the disclosure conform to the relevant provisions of national laws and regulations, and do not violate public order and good customs.

A method for training an agent, an apparatus for training an agent, an electronic device and a storage medium of the embodiments of the disclosure are described below with reference to the accompanying drawings.

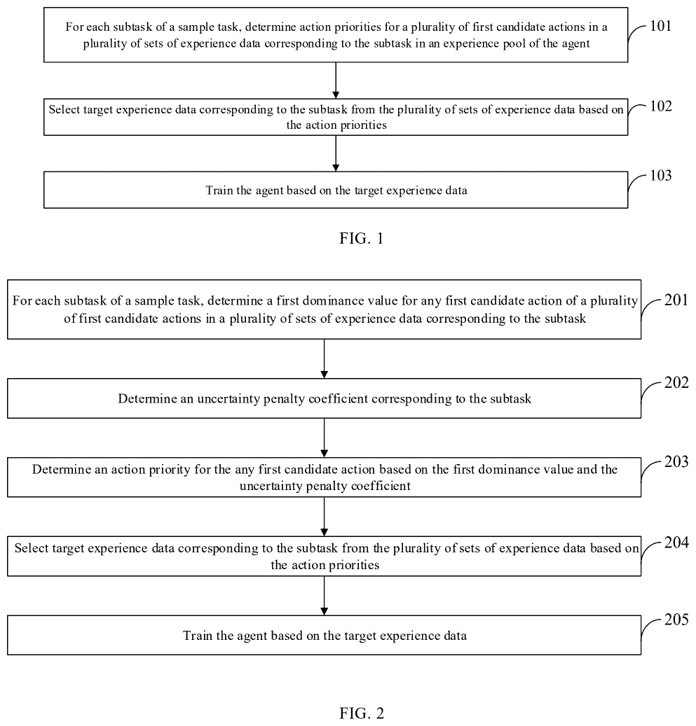

FIG. 1 is a schematic flowchart of a method for training an agent provided by an embodiment of the disclosure.

The method for training the agent in the embodiment of the disclosure can be executed by the apparatus for training the agent in the embodiment of the disclosure, and the apparatus can be configured in the electronic device.

The electronic device may be any device with a computing capability, such as a personal computer, a mobile terminal, a server, etc. The mobile terminal may be, for example, be a hardware device such as a vehicle-mounted device, a mobile phone, a tablet computer, a personal digital assistant, a wearable device, etc., with various operating systems, touch screens and/or displays.

For example, the agent in the disclosure may be a multimodal agent capable of performing graphical user interface (GUI) interactive tasks through visual input (such as screen shots) and natural language commands. Its operating range includes, but is not limited to, clicking, sliding, entering text and other operations.

For example, the agent of the disclosure may be an intelligent assistant built in an operating system (OS), such as a native agent on a mobile operating system or a personal computer (PC) end operating system, such as Windows, Android and iOS, or an agent integrated in a third-party APP.

As illustrated in FIG. 1, the method for training the agent includes the following steps.

At step 101, for each subtask of a sample task, action priorities of a plurality of first candidate actions in a plurality of sets of experience data corresponding to the subtask are determined in an experience pool of the agent.

The sample task may be determined according to an initial interface image and task instruction information.

The initial interface image may refer to a screenshot of an APP interface, and the task instruction information may refer to natural language instruction information entered by a user.

For example, the initial interface image is a screenshot of a web page, and the task instruction information is: searching for “AI” on the webpage.

For example, the agent may identify the initial interface image to obtain GUI elements in the initial interface image. It also parses the task instruction information, and determines the sample task corresponding to the task instruction information according to the GUI elements in the initial interface image and an analysis result of the task instruction information. The sample task here can be understood as an overall task for the agent to interact with the APP.

The sample task may include a plurality of subtasks. For example, by decomposing the sample task, the plurality of subtasks of the sample task are obtained.

For example, the task instruction information is “searching for “AI” on the webpage”, the sample task corresponding to the task instruction information is to search for AI on the webpage, and the sample task can be decomposed into three subtasks in order: opening a search page, entering “AI” in a search box and clicking a search control.

In the disclosure, an experience pool of the agent is used to store the experience data during the interaction between the agent and the APP. A set of experience data includes a current state, an action, a reward value, a next state, etc.

The current state in the experience data may include a current interface image and an instruction description of a subtask. The action may refer to an action performed on the current interface. The reward value refers to a reward value obtained by executing the action. The next state is a state to be achieved by executing the action in the current state, and the next state includes an interface image after executing the action and an instruction description of a next subtask.

The reward value in the experience data may be calculated based on a difference between the action in the experience data and a reference action in a reference action sequence of the sample task, or it may be calculated in other ways, which is not limited here.

For example, the experience pool of the agent may be acquired off-line, or, during the training process of the agent, for any subtask in the sample task, the agent may execute each first candidate action, that is, the agent may execute a plurality of sets of action sequences to complete an interactive task, after the agent selects a first candidate action to interact with the APP, the corresponding experience is stored in the experience pool.

Since a plurality of actions can be taken for a subtask, in the disclosure, any subtask may correspond to a plurality of sets of experience data. If a set of experience data contains one action, then the subtask may correspond to a plurality of first candidate actions.

In order to improve a training efficiency and a performance of the agent, in the disclosure, for any subtask in the sample task, the action priorities for the plurality of first candidate actions in the plurality of sets of experience data corresponding to the subtask can be determined in the experience pool of the agent, so that the experience data having high-value actions can be selected from the plurality of sets of experience data based to the action priorities as sample data to train the agent.

The action priority of the first candidate action may be used to represent a value of the first candidate action. The higher the action priority of the first candidate action, the higher the value of the first candidate action, indicating that choosing higher-value first candidate action is more beneficial to completing the sample task.

In the disclosure, a first dominance value for adopting a first candidate action for the subtask may be determined, and an action priority of the first candidate action may be determined based on the first dominance value. For example, the larger the first dominance value, the higher the action priority.

At step 102, target experience data corresponding to the subtask is selected from the plurality of sets of experience data based on the action priorities.

The target experience data may include one or more sets of experience data, which is not limited in the disclosure.

In some implementations, the plurality of sets of experience data may be ranked based on the respective action priorities in a descending order, and a preset number of experience data ranked first in a ranking result may be used as the target experience data.

In some implementations, the target experience data corresponding to the subtask is selected from the plurality of sets of experience data based on the action priorities in combination with the reward value of the first candidate action in the experience data. For example, the experience data belonging to the first candidate action with the action priority greater than a first threshold and the reward value greater than a second threshold may be determined as the target experience data.

At step 103, the agent is trained based on the target experience data.

In the disclosure, the agent is trained according to a current state and an action in the target experience data to obtain a trained agent.

For example, the parameter of the agent can be updated once based on the target experience data corresponding to the sample task.

The trained agent can be used to automate the execution of individual APP or cross-APP instructions from users. Through dynamic behavior policy capture and multi-level reward mechanism, it can solve an automatic processing problem for complex instructions put forward by users in different APPs. For example, in an e-commerce customer service scenario, the agent needs to simultaneously handle a plurality of steps such as product inquiry, order modification, and return process, and seamlessly switch among different pages (such as product detail page, order page, payment page, etc.) to ultimately fulfill user requests.

In the embodiment of the disclosure, for each subtask in the sample task, the action priorities for the first candidate actions in the plurality of sets of experience data corresponding to the subtask is determined in the experience pool, and the experience data corresponding to high-value actions can be selected from the plurality of sets of experience data corresponding to the subtask based the action priorities to train the agent, which not only improves the training efficiency of the agent, but also improves the accuracy of the agent in executing the overall task.

FIG. 2 is a schematic flowchart of a method for training an agent provided by another embodiment of the disclosure.

As illustrated in FIG. 2, the method for training the agent includes the following steps.

At step 201, for each subtask of a sample task, a first dominance value for any first candidate action of the plurality of first candidate actions in a plurality of sets of experience data corresponding to the subtask is determined.

The first dominance value of the any first candidate action represents a degree of dominance for adopting the any first candidate action relative to adopting other first candidate actions for the subtask. The larger the first dominance value, the greater the degree of dominance relative to other first candidate actions.

In some embodiments, an expected cumulative reward for adopting the any first candidate action for the subtask may be determined. For the subtask, a maximum value form expected cumulative rewards corresponding to first candidate actions other than the any first candidate action in the plurality of first candidate actions may be determined, and the first dominance value may be determined based on the expected cumulative reward corresponding to the any first candidate action and the maximum value.

For example, the expected cumulative reward may be determined with a Q-Value function based on a current state and a description of the first candidate action corresponding to the subtask. The expected cumulative reward refers to an expected value of a cumulative reward that the agent can get by adopting the first candidate action under the current state corresponding to the subtask.

For example, the first dominance value is determined based on a difference between the expected cumulative reward and the maximum value. The obtained first dominance value represents a dominance for adopting the any first candidate action relative to adopting other first candidate actions for the subtask, that is, a dominance relative to an optimal action.

As an example, the following equation (1) is used to determine the first dominance

$$A ( s , a ) = Q ( s , a ) - {mas}_{{a}^{′}} Q ( s , {a}^{′} ) \qquad ( 1 )$$

where A( ) represents a dominance function; A(s,a) indicates a dominance value of an action a relative to other possible actions under a state s, that is, a dominance of a relative to an optimal action; Q( ) represents a Q-value function, Q(s,a) represents an expected cumulative reward that the agent can get after adopting the action a under the state s; s refers to the state, a refers to the action; and

$${mas}_{{a}^{′}} Q ( s , {a}^{′} )$$

represents a maximum value form expected cumulative rewards corresponding to all possible actions a′ under the state s.

Therefore, based on the expected cumulative reward of the any first candidate action and the maximum value from the expected cumulative rewards corresponding to other first candidate actions, a dominance of the any first candidate action relative to the optimal action in other first candidate actions can be determined, which improves an accuracy of the dominance value.

In some embodiments, an average value of the expected cumulative rewards of the plurality of first candidate actions for the subtask can be determined, and the first dominance value may be determined based on a difference between the expected cumulative reward of the any first candidate action and the average value. The first dominance value may be a dominance value for adopting the any first candidate action relative to an average action for the subtask.

At step 202, an uncertainty penalty coefficient corresponding to the subtask is determined.

The uncertainty penalty coefficient represents a degree of uncertainty in action selection by the agent for the subtask. The greater the uncertainty penalty coefficient, the higher the uncertainty, and the smaller the uncertainty penalty coefficient, the lower the uncertainty.

In some embodiments, a first probability for adopting the any first candidate action for the subtask is determined based on expected cumulative rewards corresponding to the plurality of first candidate actions, and the uncertainty penalty coefficient may be determined based on first probabilities respectively corresponding to the plurality of the first candidate actions.

For example, the first probability may be determined based on a ratio of the expected cumulative reward of the any first candidate action to a sum of the expected cumulative rewards corresponding to the plurality of first candidate actions.

As an example, the first probability is determined by the following equations (2) and (3):

$$Uncertainty ( s ) = - {\sum }_{i} {p}_{i} log {p}_{i} \qquad ( 2 )$$

$${p}_{i} = \frac{exp ( Q ( s , {a}_{i} ) / τ )}{{\sum }_{j} exp ( Q ( s , {a}_{i} ) / τ )} \qquad ( 3 )$$

where Uncertainty(s) represents an uncertainty penalty coefficient under the state s, and the state s is a state corresponding to the subtask; pᵢ represents a probability for adopting an action aᵢ under the state s; and τ is a positive real number, and is used to control a smoothness of probability distribution pᵢ. For example, the larger the τ, the smoother the probability distribution pᵢ, and the smaller a probability difference between different actions, which means that the agent can explore more randomly rather than limiting to a few actions with high expected cumulative rewards. Moreover, the smaller the τ, the sharper the probability distribution pᵢ, that is, the agent tends to choose actions with higher probability, which means that the agent prefers to choose actions with higher expected cumulative rewards based on known information.

Therefore, according to the expected cumulative rewards of the plurality of first candidate actions of the subtask, the probability for adopting any first candidate action for the subtask is determined, and an uncertainty of action selection of the agent for the subtask is determined according to the probabilities of respective first candidate action, thus improving an accuracy of the uncertainty.

At step 203, an action priority for the any first candidate action is determined based on the first dominance value and the uncertainty penalty coefficient.

In some embodiments, the first dominance value and the uncertainty penalty coefficient can be weighted, respectively, according to a weight of the first dominance value and a weight of the uncertainty penalty coefficient, to obtain the action priority.

As an example, the action priority is determined according to the following equation (4):

$$priority ( s , a ) = α * \vert A ( s , a ) \vert + β * Uncertainty ( s ) \qquad ( 4 )$$

where priority(s,a) represents an action priority of the action a under the state s, i.e., the action priority of the action a corresponding to the subtask, α and β being hyper-parameters, indicating weights.

At step 204, target experience data corresponding to the subtask is selected from the plurality of sets of experience data based on the action priorities.

At step 205, the agent is trained based on the target experience data.

In the disclosure, steps 204-205 are implemented by any implementation of the embodiments of the disclosure, which will not be repeated here.

In the embodiment of the disclosure, the action priority is determined based on the dominance value of the first candidate action and the uncertainty of the subtask, which guarantees a gain and a fluctuation of the current policy and improves an accuracy of the action priority, thereby improving an accuracy of the target experience data selected. The agent can be trained based on the target experience data, which can further improve an accuracy of the agent in executing tasks.

FIG. 3 is a schematic flowchart of a method for training an agent provided by yet another embodiment of the disclosure.

As illustrated in FIG. 3, the method for training the agent includes the following steps.

At step 301, for each subtask of a sample task, action priorities of a plurality of first candidate actions in a plurality of sets of experience data corresponding to the subtask is determined in an experience pool of the agent.

At step 302, target experience data corresponding to the subtask is selected from the plurality of sets of experience data based on the action priorities.

In the disclosure, steps 301-302 are implemented by any implementation of the embodiments of the disclosure, which will not be repeated here.

At step 303, a reward value for a second candidate action in the target experience data is determined.

In some embodiments, the reward value in the target experience data may be used as the reward value of the second candidate action in the target experience data. The reward value in the target experience data may be calculated based on a difference between an action in experience data and a reference action in a reference action sequence of the sample task, or it may also be a preset reward value of the subtask.

In order to avoid getting stuck in a local optimization when using instant reward, in some embodiments, an instant reward for adopting the second candidate action for the subtask is determined, a long-term reward for completing the sample task is predicted in a case of adopting the second candidate action for the subtask, and a reward value for the second candidate action is determined based on the instant reward and the long-term reward.

Instant reward refers to a feedback obtained immediately after performing an action under a specific state, which is used to evaluate an immediate effect of the action. The instant reward of the second candidate action is understood as a feedback obtained immediately after performing the second candidate action under the current state corresponding to the subtask.

Long-term reward refers to a sum of all possible cumulative rewards that the agent will get in the future starting from the current state, which reflects a potential impact of the action on future gains. The long-term reward corresponding to the second candidate action can be understood as a sum of all possible cumulative rewards in the future after the agent adopts the second candidate action for the subtask.

For example, the instant reward and the long-term reward can be weighted, respectively, according to a weight of the instant reward and a weight of the long-term reward, and a reward value of the second candidate action may be determined.

The weight of the instant reward and the weight of the long-term reward may be preset or adjusted according to actual needs. For example, the weight of the instant reward and the weight of the long-term reward may be adjusted dynamically according to an importance of different subtasks in the sample task.

As an example, the reward value for the second candidate action is determined by the following equation (5):

$${r}_{t} = γ \cdot {r}_{inst ( {s}_{t} , c )} + ( 1 - γ ) \cdot {V}_{goa l ( {s}_{t} , c )} \qquad ( 5 )$$

where rₜ represents a reward value for a second candidate action corresponding to a subtask t; rᵢₙₛₜ₍ₛ_{ₜ}_{,c)} represents an instant reward; V_{goal(s}_{ₜ}_{,c)} represents a long-term reward; and γ represents a super-parameter.

For example, a matching degree between an instruction description of the subtask and a current interface state corresponding to the subtask is determined, and an instant reward is determined based on the matching degree. Therefore, the instant reward can be determined based on a matching condition between the instruction description of the subtask and the current interface state, which can improve an accuracy of the instant reward.

For example, the current interface state is embodied in the form of a current interface image, so the matching degree between the instruction description of the subtask and the current interface image of the subtask can be taken as the matching degree between the instruction description of the subtask and the current interface state of the subtask.

For example, the current interface state may be obtained through identifying the current interface image, and the current interface state may include information such as GUI elements in the current interface and positions of the GUI elements, so that the matching degree between the instruction description of the subtask and the information can be calculated.

For example, a completion probability of the sample task may be predicted based on task instruction information of the sample task and the current interface state corresponding to the subtask, and the long-term reward may be determined based on the completion probability. Therefore, the completion probability of the sample task is predicted based on the task instruction information of an overall task and the current interface state, and is used to determine the long-term reward.

For example, the completion probability is predicted with a goal-oriented value function based on the task instruction information of the sample task and the current interface state.

For example, based on the completion probability, the long-term reward corresponding to the completion probability is determined by querying a mapping relationship between a probability and a reward.

Therefore, the reward value of the second candidate action is determined based on the instant reward and the long-term reward, to achieve a tradeoff of a short-term goal and a long-term goal. The agent can be trained based on the reward value, which improves an accuracy of action selection of the agent.

At step 304, the agent is trained based on the reward value of the second candidate action.

In some embodiments, the target action is selected from second candidate actions according to reward values for the second candidate actions, and the second probability for selecting the target action for the subtask and a second dominance value of the target action are determined. The agent is then trained based on the second probability, the second dominance value and the reward values for the second candidate actions corresponding to each subtask.

For example, the candidate action having a largest reward value for the second candidate actions is taken as the target action of the subtask. For example, one subtask corresponds to three sets of target experience data, and each set of target experience data includes one second candidate action, so there are three second candidate actions, and the action having the largest reward is selected from the three second candidate actions as the target action, i.e., the action selected for the subtask.

For example, based on the current state corresponding to the subtask, the instruction description of the subtask, and the target action, etc., a policy function can be used to determine the second probability for selecting the target action for the subtask.

For example, a calculation method for the second dominance value of the target action is similar to a calculation method for the first dominance value of the first candidate action in the above embodiment, and the details will not be repeated here.

Therefore, based on the reward value for the second candidate action, the agent is trained in combination with the probability for selecting the target action for the subtask and the dominance value of the target action, so that the agent can learn a capability to select an appropriate action, which improves an accuracy of the agent in executing the overall task.

In some embodiments, the agent may include a large model and a policy network. The policy network is used to select an action based on a vector output by the large model, and parameters of the large model and the policy network can be adjusted, separately, when training the agent.

For example, the parameters of the large model are adjusted based on the reward values for the second candidate actions to obtain the large model with adjusted parameters, the parameters of the policy network are adjusted based on the second probability and the second dominance value to obtain the policy network with adjusted parameters, so that a trained agent can be obtained based on the large model with the adjusted parameters and the policy network with the adjusted parameters.

Therefore, the parameters of the large model are adjusted based on the reward values for the second candidate actions, and the parameters of the policy network are adjusted based on the second probability and the second dominance value, which can improve an accuracy of parameter adjustment, thereby improving an accuracy of the agent.

Meta-learning is a learning method that enables a model to quickly adapt to new tasks or environments. For example, a meta-learning policy is used to update and adjust the parameters of the large model, and the parameters of the large model are adjusted based on the reward values of the second candidate actions in the following way. Based on the reward value of the target action having the largest reward value for the plurality of second candidate actions and the expected reward values of the candidate actions other than the target action in the plurality of second candidate actions, a meta-gradient is determined. The parameters of the large model are adjusted based on the meta-gradient to obtain the large model with the adjusted parameters.

Meta-gradient refers to a gradient used to update model parameters during meta-learning.

For example, the meta-gradient is determined based on a current model parameter gradient of the large model, the reward value of the target action, and the expected reward values of the candidate actions other than the target action in the plurality of second candidate actions.

As an example, the meta-gradient is determined by the following equation (6), and the parameters to be adjusted of the large model are determined by the equation (7):

$${g}_{meta} = {∇}_{θ} {E}_{v} [ log {π}_{θ} ( a \vert s , c ) * ( {\sum }_{t = 1}^{T} {r}_{t} - {E}_{{θ}^{′}} [ {\sum }_{t = 1}^{T} {r}_{t} ] ) ] \qquad ( 6 )$$

$${θ}_{new} = θ - η * {g}_{meta} \qquad ( 7 )$$

where gₘₑₜₐ represents a meta-gradient; ∇_{θ} represents a gradient of a parameter θ of the large model in the last iteration; π_{θ}( ) represents a current policy function corresponding to the large model, which is used for generating actions, a represents an action, s represents a state, and c represents an instruction description of a subtask corresponding to the state s; T represents the number of subtasks of the sample task; E_{θ′} represents an expected reward of another second candidate action other than the target action in the plurality of second candidate actions, that is, an expected reward when a different policy is adopted; θ_{new} represents an adjusted parameter of the large model; and η represents a weight.

Therefore, the meta-gradient is determined based on the reward value of the target action and the expected reward values of other candidate actions, which can be used to dynamically adjust the parameters of the large model, so that the agent can quickly adapt to automation tasks in different environments.

For example, a loss of the policy network is determined based on the second probability and the second dominance value, and the parameters of the policy network are adjusted based on the loss.

As an example, the loss of the policy network is determined according to the following equation (8):

$${L}_{AWR} = - {E}_{v} [ log π ( a \vert s , c ) * exp ( A ( s , a , c ) ) / β ] \qquad ( 8 )$$

where L_{AWR} represents the loss of the policy network; E_{V} represents an expectation; π( ) represents a policy function; and A( ) represents a dominance function.

In the embodiment of the disclosure, the reward value of the second candidate action is determined in the target experience pool, and the agent is trained based on the reward value of the second candidate action, which improves a training efficiency and a performance of the agent.

In the method for training the agent of the disclosure, the target experience data having the high-value actions can be selected from the experience pool based on the action priorities, and the target experience data is used for training the agent. The reward value of the action in the target experience data can be calculated based on the short-term reward and the long-term reward, so that the agent can be trained based on the reward value, which improves a training efficiency. Therefore, an accuracy of the agent in executing the overall task and a generalization capability of the agent in different dynamic environments can be improved.

In a reasoning application stage, the agent obtains the initial interface image input by the user and the task instruction information of the interactive task, in which the interactive task can be decomposed into a plurality of subtasks. For each subtask, the method for calculating the reward value for the second candidate action in the above embodiment can be used to determine reward values of optional actions corresponding to the subtask. The action having the largest reward is taken as the target action, and the target action is executed to complete the subtask, which improves an accuracy of selecting the target action, and improves an accuracy of executing the interactive task.

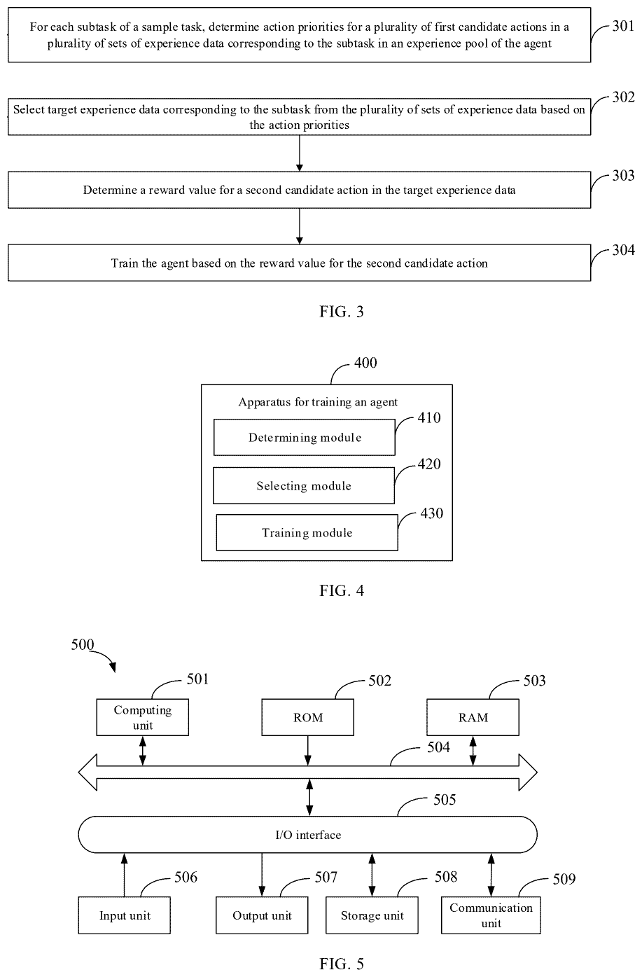

In order to realize the above embodiments, the embodiment of the disclosure also provides an apparatus for training an agent. FIG. 4 is a schematic structural diagram of an apparatus for training an agent provided by an embodiment of the disclosure.

As illustrated in FIG. 4, the apparatus for training the agent 400 includes:
a determining module 410, configured to, for each subtask of a sample task, determine action priorities for a plurality of first candidate actions in a plurality of sets of experience data corresponding to the subtask in an experience pool of the agent, in which the action priorities represent values of the plurality of the first candidate actions;
a selecting module 420, configured to select target experience data corresponding to the subtask from the plurality of sets of experience data based on the action priorities; and
a training module 430, configured to train the agent based on the target experience data.

Optionally, the determining module 410 is further configured to:
determine a first dominance value for any first candidate action of the plurality of first candidate actions;
determine an uncertainty penalty coefficient corresponding to the subtask, in which the uncertainty penalty coefficient represents a degree of uncertainty in action selection; and
determine an action priority for the any first candidate action based on the first dominance value and the uncertainty penalty coefficient.

Optionally, the determining module 410 is further configured to:
determine an expected cumulative reward for adopting the any first candidate action for the subtask;
for the subtask, determine a maximum value from expected cumulative rewards corresponding to first candidate actions other than the any first candidate action in the plurality of the first candidate actions; and
determine the first dominance value based on the expected cumulative reward corresponding to the any first candidate action and the maximum value.

Optionally, the determining module 410 is further configured to:
determine an expected cumulative reward for adopting the any first candidate action for the subtask;
determine a first probability for adopting the any first candidate action for the subtask based on expected cumulative rewards corresponding to the plurality of the first candidate actions; and
determine the uncertainty penalty coefficient based on first probabilities respectively corresponding to the plurality of the first candidate actions.

Optionally, the training module 430 is further configured to:
determine a reward value for a second candidate action in the target experience data; and
train the agent based on the reward value of the second candidate action.

Optionally, the training module 430 is further configured to:
determine an instant reward for adopting the second candidate action for the subtask;
predict a long-term reward for completing the sample task in a case of adopting the second candidate action for the subtask; and
determine the reward value based on the instant reward and the long-term reward.

Optionally, the training module 430 is further configured to:
determine a matching degree between an instruction description of the subtask and a current interface state corresponding to the subtask; and
determine the instant reward based on the matching degree.

Optionally, the training module 430 is further configured to:
predict a completion probability of the sample task based on task instruction information of the sample task and a current interface state corresponding to the subtask; and
determine the long-term reward based on the completion probability.

Optionally, the training module 430 is further configured to:
select a target action from second candidate actions according to reward values for the second candidate actions;
determine a second probability for selecting the target action for the subtask and a second dominance value of the target action; and
train the agent based on the second probability, the second dominance value and the reward values for the second candidate actions.

Optionally, the training module 430 is further configured to:
adjust parameters of a large model in the agent based on the reward values for the second candidate actions to obtain the large model with adjusted parameter;
adjust parameters of a policy network in the agent based on the second probability and the second dominance value to obtain the policy network with adjusted parameter; and
obtain a trained agent based on the large model with the adjusted parameters and

the policy network with the adjusted parameters.

Optionally, there are a plurality of second candidate actions, and the training module 430 is further configured to:
determine a meta-gradient based on a reward value of a target action having a largest reward value for the plurality of second candidate actions and expected values of reward values of candidate actions other than the target action in the plurality of second candidate actions; and
adjust the parameters of the large model based on the meta-gradient to obtain the large model with adjusted parameters.

It should be noted that the above explanation of the embodiments of the method for training the agent is also applicable to the apparatus for training the agent in the embodiment, which will not be repeated here.

In the embodiment of the disclosure, for each subtask in the sample task, the action priorities for the first candidate actions in the plurality of sets of experience data corresponding to the subtask are determined in the experience pool, and the experience data corresponding to high-value actions can be selected from the plurality of sets of experience data corresponding to the subtask based on the action priorities to train the agent, which not only improves a training efficiency of the agent, but also improves an accuracy of the agent in executing the overall task.

According to the embodiments of the disclosure, the disclosure also provides an electronic device, a readable storage medium and a computer program product.

FIG. 5 is a schematic block diagram illustrating an example electronic device 500 that can be used to implement the embodiments of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown here, their connections and relations, and their functions are merely examples, and are not intended to limit the implementations of the disclosure described and/or required herein.

As illustrated in FIG. 5, the device 500 includes: a computing unit 501 for performing various appropriate actions and processes according to computer programs stored in a read-only memory (ROM) 502 or computer programs loaded from a storage unit 508 to a random access memory (RAM) 503. The RAM 503 may also stores necessary programs and data for the device 500 to operate. The computing unit 501, the ROM 502 and the RAM 503 are connected to each other through a bus 504. An input/output (I/O) interface 505 is also connected to the bus 504.

Components in the device 500 are connected to the I/O interface 505, including: an input unit 506, such as a keyboard and a mouse; an output unit 507, such as various types of displays and speakers; the storage unit 508, such as a disk and an optical disk; and a communication unit 509, such as a network card, a modem and a wireless communication transceiver. The communication unit 509 allows the device 500 to exchange information/data with other devices through a computer network such as the Internet and/or various telecommunication networks.

The computing unit 501 may be various general-purpose and/or dedicated processing components having processing and computing capabilities. Some examples of the computing unit 501 include, but are not limited to, a central processing unit (CPU), a graphics processing unit (GPU), various dedicated AI computing chips, various computing units that run machine learning model algorithms, a digital signal processor (DSP) and any appropriate processor, controller or microcontroller. The computing unit 501 executes the various methods and processes described above, such as the method for training the agent. For example, in some embodiments, the above method may be implemented as a computer software program, which is tangibly contained in a machine readable medium, such as the storage unit 508. In some embodiments, part or all of the computer programs may be loaded and/or installed on the device 500 via the ROM 502 and/or the communication unit 509. When the computer program is loaded on the RAM 503 and executed by the computing unit 501, one or more steps of the above method may be executed. Alternatively, in other embodiments, the computing unit 501 may be configured to perform the above method in any other suitable manner (for example, by means of firmware).

Various implementations of the systems and techniques described above may be implemented by a digital electronic circuit system, an integrated circuit system, a field programmable gate array (FPGA), an application-specific integrated circuit (ASIC), an application specific standard product (ASSP), a system on chip (SOC), a complex programmable logic device (CPLD), a computer hardware, firmware, or software, and/or any combination thereof. These implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting the data and instructions to the storage system, the at least one input device and the at least one output device.

The program code configured to implement the method of the disclosure may be written in any combination of one or more programming languages. These program codes may be provided to a processor or a controller of a general-purpose computer, a dedicated computer or any other programmable data processing device, so that when the program codes are executed by the processor or the controller, the functions or operations specified in the flowchart and/or block diagram can be implemented. The program codes may be executed entirely on the machine, or partly executed on the machine, or partly executed on the machine and partly executed on the remote machine as an independent software package, or entirely executed on the remote machine or a server.

In the context of the disclosure, a machine-readable medium may be a tangible medium that may contain or store programs for use by or in combination with an instruction execution system, an apparatus, or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium include electrical connections based on one or more wires, portable computer disks, hard disks, RAMs, ROMs, electrically programmable ROMs (EPROMs) or flash memories, fiber optics, compact disc ROMs (CD-ROMs), optical storage devices, magnetic storage devices, or any suitable combination thereof.

In order to provide interaction with a user, the systems and techniques described herein may be implemented on a computer having a display device (e.g., a cathode ray tube (CRT) or a liquid crystal display (LCD) monitor) for displaying information to the user; and a keyboard and a pointing device (such as a mouse or a trackball) via which the user can provide input to the computer. Other kinds of devices may also be used to provide interaction with the user. For example, the feedback provided to the user may be any form of sensory feedback (e.g., visual feedback, auditory feedback or haptic feedback), and the input from the user may be received in any form (including acoustic input, voice input or tactile input).

The systems and technologies described herein can be implemented in a computing system that includes back-end components (for example, a data server), or a computing system that includes middleware components (for example, an application server), or a computing system that includes front-end components (for example, a user computer with a GUI or a web browser, through which the user can interact with the implementations of the systems and technologies described herein), or a computing system that includes any combination of such back-end components, middleware components and front-end components. The components of the system may be interconnected by any form or medium of digital data communication (e.g., a communication network). The communication network may include, for example, a local area network (LAN), a wide area network (WAN), the Internet and a block-chain network.

The computer system may include a client and a server. The client and the server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and virtual private server (VPS) services. The server may be a server of a distributed system, or a server combined with a block-chain.

According to the embodiment of the disclosure, the disclosure also provides a computer program product. When instructions stored in the computer program product are executed by an instruction processor, the method for training the agent proposed in the above embodiments of the disclosure is implemented.

It is understandable that the steps can be reordered, added or deleted using various forms of the processes shown above. For example, the steps in the disclosure may be performed in parallel, sequentially or in different orders, as long as the desired results of the technical solutions disclosed in the disclosure are achieved, which is not limited herein.

The specific implementations described above do not constitute a limitation on the scope of protection of the disclosure. It should be understood by those skilled in the art that various modifications, combinations, sub-combinations and substitutions can be made depending on the design requirements and other factors. Any modifications, equivalent substitutions and improvements made within the spirit and principles of the disclosure shall be included in the scope of protection of the disclosure.

What is claimed is:

1. A method for training an agent, comprising:
for each subtask of a sample task, determining action priorities for a plurality of first candidate actions in a plurality of sets of experience data corresponding to the subtask in an experience pool of the agent, wherein the action priorities represent values of the plurality of the first candidate actions;
selecting target experience data corresponding to the subtask from the plurality of sets of experience data based on the action priorities; and
training the agent based on the target experience data.

2. The method of claim 1, wherein determining the action priorities for the plurality of the first candidate actions in the plurality of sets of experience data corresponding to the subtask in the experience pool of the agent comprises:
determining a first dominance value for any first candidate action of the plurality of first candidate actions;
determining an uncertainty penalty coefficient corresponding to the subtask, wherein the uncertainty penalty coefficient represents a degree of uncertainty in action selection; and
determining an action priority for the any first candidate action based on the first dominance value and the uncertainty penalty coefficient.

3. The method of claim 2, wherein determining the first dominance value for the any first candidate action of the plurality of the first candidate actions comprises:
determining an expected cumulative reward for adopting the any first candidate action for the subtask;
for the subtask, determining a maximum value from expected cumulative rewards corresponding to first candidate actions other than the any first candidate action in the plurality of the first candidate actions; and
determining the first dominance value based on the expected cumulative reward corresponding to the any first candidate action and the maximum value.

4. The method of claim 2, wherein determining the uncertainty penalty coefficient corresponding to the subtask comprises:
determining an expected cumulative reward for adopting the any first candidate action for the subtask;
determining a first probability for adopting the any first candidate action for the subtask based on expected cumulative rewards corresponding to the plurality of the first candidate actions; and
determining the uncertainty penalty coefficient based on first probabilities respectively corresponding to the plurality of the first candidate actions.

5. The method of claim 1, wherein training the agent based on the target experience data comprises:
determining a reward value for a second candidate action in the target experience data; and
training the agent based on the reward value of the second candidate action.

6. The method of claim 5, wherein determining the reward value for the second candidate action in the target experience data comprises:
determining an instant reward for adopting the second candidate action for the subtask;
predicting a long-term reward for completing the sample task in a case of adopting the second candidate action for the subtask; and
determining the reward value based on the instant reward and the long-term reward.

7. The method of claim 6, wherein determining the instant reward for adopting the second candidate action for the subtask comprises:
determining a matching degree between an instruction description of the subtask and a current interface state corresponding to the subtask; and
determining the instant reward based on the matching degree.

8. The method of claim 6, wherein predicting the long-term reward for completing the sample task in the case of adopting the second candidate action for the subtask comprises:
predicting a completion probability of the sample task based on task instruction information of the sample task and a current interface state corresponding to the subtask; and
determining the long-term reward based on the completion probability.

9. The method of claim 5, wherein training the agent based on the reward value for the second candidate action comprises:
selecting a target action from second candidate actions according to reward values for the second candidate actions;
determining a second probability for selecting the target action for the subtask and a second dominance value of the target action; and
training the agent based on the second probability, the second dominance value and the reward value for the second candidate action.

10. The method of claim 9, wherein training the agent based on the second probability, the second dominance value and the reward value for the second candidate action comprises:
adjusting parameters of a large model in the agent based on the reward value for the second candidate action to obtain the large model with adjusted parameters;
adjusting parameters of a policy network in the agent based on the second probability and the second dominance value to obtain the policy network with adjusted parameters; and
obtaining a trained agent based on the large model with the adjusted parameters and the policy network with the adjusted parameters.

11. The method of claim 10, wherein there are a plurality of second candidate actions, and adjusting the parameters of the large model in the agent based on the reward value for the second candidate action to obtain the large model with the adjusted parameters comprises:
determining a meta-gradient based on a reward value of a target action having a largest reward value for the plurality of second candidate actions and expected values of reward values of candidate actions other than the target action in the plurality of second candidate actions; and
adjusting the parameters of the large model based on the meta-gradient to obtain the large model with adjusted parameters.

12. An electronic device, comprising:
at least one processor; and
a memory communicatively connected to the at least one processor;
wherein the memory stores instructions executable by the at least one processor, and when the instructions are executed by the at least one processor, the at least one processor is caused to:
for each subtask of a sample task, determine action priorities for a plurality of first candidate actions in a plurality of sets of experience data corresponding to the subtask in an experience pool of the agent, wherein the action priorities represent values of the plurality of the first candidate actions;
select target experience data corresponding to the subtask from the plurality of sets of experience data based on the action priorities; and
train the agent based on the target experience data.

13. The electronic device of claim 12, wherein the at least one processor is caused to:
determine a first dominance value for any first candidate action of the plurality of first candidate actions;
determine an uncertainty penalty coefficient corresponding to the subtask, wherein the uncertainty penalty coefficient represents a degree of uncertainty in action selection; and
determine an action priority for the any first candidate action based on the first dominance value and the uncertainty penalty coefficient.

14. The electronic device of claim 13, wherein the at least one processor is caused to:
determine an expected cumulative reward for adopting the any first candidate action for the subtask;
for the subtask, determine a maximum value from expected cumulative rewards corresponding to first candidate actions other than the any first candidate action in the plurality of the first candidate actions; and
determine the first dominance value based on the expected cumulative reward corresponding to the any first candidate action and the maximum value.

15. The electronic device of claim 13, wherein the at least one processor is caused to:
determine an expected cumulative reward for adopting the any first candidate action for the subtask;
determine a first probability for adopting the any first candidate action for the subtask based on expected cumulative rewards corresponding to the plurality of the first candidate actions; and
determine the uncertainty penalty coefficient based on first probabilities respectively corresponding to the plurality of the first candidate actions.

16. The electronic device of claim 12, wherein the at least one processor is caused to:
determine a reward value for a second candidate action in the target experience data; and
train the agent based on the reward value of the second candidate action.

17. The electronic device of claim 16, wherein the at least one processor is caused to:
determine an instant reward for adopting the second candidate action for the subtask;
predict a long-term reward for completing the sample task in a case of adopting the second candidate action for the subtask; and
determine the reward value based on the instant reward and the long-term reward.

18. The electronic device of claim 17, wherein the at least one processor is caused to:
determine a matching degree between an instruction description of the subtask and a current interface state corresponding to the subtask; and
determine the instant reward based on the matching degree.

19. A non-transitory computer-readable storage medium having computer instructions stored thereon, wherein the computer instructions are used to cause a computer to implement the method comprising:
for each subtask of a sample task, determining action priorities for a plurality of first candidate actions in a plurality of sets of experience data corresponding to the subtask in an experience pool of the agent, wherein the action priorities represent values of the plurality of the first candidate actions;
selecting target experience data corresponding to the subtask from the plurality of sets of experience data based on the action priorities; and
training the agent based on the target experience data.

20. A computer program product comprising a computer program, wherein when the computer program is executed by a processor, the steps of the method of claim 1 are implemented.
